(19) United States
(12) Patent Application Publication
(10) Pub. No.: US 2014/0138587 A1
(43) Pub. Date: May 22, 2014

(54) COVALENT MODIFICATION AND CROSSLINKING OF CARBON MATERIALS BY SULFUR ADDITION

(71) Applicants: Matteo Pasquali, Houston, TX (US); Bryan Thomas Whiting, Doylestown, OH (US)

(72) Inventors: Matteo Pasquali, Houston, TX (US); Bryan Thomas Whiting, Doylestown, OH (US)

(73) Assignee: William Marsh Rice University, Houston, TX (US)

(21) Appl. No.: 14/075,559

(22) Filed: Nov. 8, 2013

Related U.S. Application Data
(60) Provisional application No. 61/723,875, filed on Nov. 8, 2012.

(51) Int. Cl. C01B 31/02; B01J 19/12; H01B 1/04

(52) U.S. Cl. CPC C01B 31/0253; H01B 1/04; B01J 19/123
USPC 252/500; 423/439; 204/157.47

(57) ABSTRACT

In some embodiments, the present disclosure pertains to methods of forming cross-linked carbon materials by: (a) associating a sulfur source with carbon materials, where the sulfur source comprises sulfur atoms; and (b) initiating a chemical reaction, where the chemical reaction leads to the formation of covalent linkages between the carbon materials. In some embodiments, the covalent linkages between the carbon materials comprise covalent bonds between sulfur atoms of the sulfur source and carbon atoms of the carbon materials. In some embodiments, the chemical reactions occur in the absence of solvents while carbon materials are immobilized in solid state. In some embodiments, the carbon materials include carbon nanotube fibers. In some embodiments, the methods of the present disclosure also include a step of doping carbon materials with a dopant, such as iodine. Further embodiments of the present disclosure pertain to cross-linked carbon materials formed in accordance with the above methods.

### CROSS-REFERENCE TO RELATED APPLICATIONS

This application claims priority to U.S. Provisional Patent Application No. 61/723,875, filed on Nov. 8, 2012. The entirety of the aforementioned application is incorporated herein by reference.

### STATEMENT REGARDING FEDERALLY SPONSORED RESEARCH

This invention was made with government support under Air Force Office of Scientific Research Grant No. FA9550-12-1-0035, awarded by the U.S. Department of Defense. The Government has certain rights in the invention.

### BACKGROUND

Current methods of forming aggregated or bundled carbon materials suffer from numerous limitations, including lack of efficacy, stringent reaction conditions, and inconsistent results. Therefore, a need exists for more effective methods of forming various types of carbon materials in aggregated or bundled forms.

### BRIEF SUMMARY

In some embodiments, the present disclosure pertains to methods of forming cross-linked carbon materials. In some embodiments, such methods comprise: (a) associating a sulfur source with carbon materials; and (b) initiating a chemical reaction, where the chemical reaction leads to the formation of covalent linkages between the carbon materials. In some embodiments, the covalent linkages between the carbon materials comprise covalent bonds between sulfur atoms of the sulfur source and carbon atoms of the carbon materials.

In some embodiments, the carbon materials used in accordance with the methods of the present disclosure comprise non-polymeric carbon materials, such as carbon nanotubes, carbon nanotube fibers, carbon nanotube foams, carbon fibers, carbon foams, fullerenes, fluorenes, C₆₀, carbon films, graphenes, exfoliated graphite, graphene nanoribbons, graphite and combinations thereof. In some embodiments, the sulfur source includes, without limitation, elemental sulfur, oligomeric sulfur, 2,2′-dithiobis(benzothiazole) (DTBT), tetramethylthiuram disulfide (TMTD), phenyl-phenylthiosulfonate, benzenesulfonamide, phenyl thiobenzoate, 2-mercaptobenzothiazole, 2-mercaptobenzoxazole, diphenyl disulfide, 2-mercaptobenzimidazole, 1,3,4-thiadiazole-2,5-dithiol, and combinations thereof.

In some embodiments, the chemical reactions in accordance with the methods of the present disclosure occur in the absence of solvents. In some embodiments, the chemical reactions occur in the absence of surfactants. In some embodiments, carbon materials are immobilized in a reaction chamber in solid state during the chemical reaction.

In some embodiments, chemical reactions are initiated by heating. In some embodiments, the heating occurs between about 150° C. to about 200° C. In some embodiments, the methods of the present disclosure also include a step of terminating the chemical reactions by various methods, such as by cooling.

In some embodiments, the methods of the present disclosure also include a step of doping the carbon materials with a dopant. In some embodiments, the doping occurs during the chemical reactions. In some embodiments, the doping occurs after the chemical reactions. In some embodiments, the dopant is one or more halogens, such as iodine, chlorine, bromine, and combinations thereof.

Further embodiments of the present disclosure pertain to cross-linked carbon materials formed in accordance with the methods of the present disclosure. In some embodiments, the cross-linked carbon materials comprise non-polymeric carbon materials and covalent linkages between the carbon materials. In some embodiments, the covalent linkages comprise sulfur bridges between the carbon materials. In some embodiments, the sulfur bridges comprise covalent bonds between sulfur atoms and carbon atoms of the carbon materials. In some embodiments, the cross-linked carbon materials further comprise a dopant, such as iodine, chlorine, bromine, and combinations thereof.

### BRIEF DESCRIPTION OF THE FIGURES

FIG. 1 provides an exemplary scheme for forming cross-linked carbon materials.

FIG. 2 provides images illustrating various mechanisms and reaction conditions for forming cross-linked carbon nanotube (CNT) materials. FIG. 2A provides a general scheme where CNTs are cross-linked to one another through covalent linkages. FIG. 2B provides a more detailed mechanism where sulfur vulcanization is applied to CNT-based materials and sulfur-based radicals are added to CNT sidewalls to eventually bridge adjacent CNTs. FIG. 2C provides an exemplary image of a reaction chamber for forming carbon materials.

FIG. 3 provides a scheme for sulfur-based vulcanization of CNT fibers (FIG. 3A), and the initial vulcanization results of the cross-linked CNT fibers (FIG. 3B), where properties are reported in comparison to untreated CNT fibers. Reactions were heated to ˜200° C. overnight.

FIG. 4 provides data relating to the testing efficiency of various vulcanization agents. Properties are reported in comparison to untreated CNT fibers. Both tensile strength and elastic modulus increase with increasing ratio of 2,2′-dithiobis(benzothiazole) (DTBT) to tetramethylthiuram disulfide (TMDT).

FIG. 5 provides data relating to the effect of vulcanization reaction times on the properties of the vulcanized CNT fibers. Properties are reported in comparison to untreated CNT fiber. All reactions were heated to 200° C. with 3 mg DTBT.

FIG. 6 provides data relating to the effect of iodine doping on vulcanized CNT fibers. Properties are reported in comparison to untreated CNT fiber. Reactions were performed at 200° C. for 20 hours. For the 2-step protocol, vulcanization was performed first for 20 hours, followed by iodine curing for 20 additional hours.

FIG. 7 provides overlaid Raman spectra of untreated and cross-linked CNT fibers. A decrease in the G-band to D-band is indicative of CNT covalent modification.

FIG. 8 provides a scheme (FIG. 8A) and data (FIGS. 8B-C) relating to sulfur vulcanization as applied to CNT foams. FIG. 8B provides x-ray photoelectron spectroscopy (XPS) data showing presence of sulfur after crosslinking. FIG. 8C provides images relating to severe reduction in solubility of cross-linked CNT foam in chlorosulfonic acid (left) compared to highly soluble untreated foam (right).

FIG. 9 provides images of CNT fibers before sulfur vulcanization (FIG. 9A) and after sulfur vulcanization (FIG. 9B).

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Carbon nanotubes (CNTs) are unique molecules because of their combination of exceptional mechanical, electrical, and thermal properties. However, there have been difficulties translating these properties from the single-molecule to the macro scale.

Various post-processing methods have been developed to increase the strength of macroscopic CNT materials, such as fibers, films, coatings, tapes, foams, and the like. For instance, methods have been developed for polymer-CNT composite fiber formation through resin infiltration into gaps in the CNT fibers and subsequent curing. However, these methods are incompatible with wet-spun fibers because of the very small empty volume available compared to those made by solid-state spinning, as well as infiltration difficulties due to highly packed and crystalline CNT bundles.

Other post-processing methods for CNT materials include: (1) irradiative curing of CNT materials to cause outer wall fusion between neighboring CNTs; (2) CNT surface modification followed by polymer growth and crosslinking; and (3) radical coupling of CNT materials by diazonium aromatic compounds. However, these methods suffer from a number of drawbacks, such as scalability, destructive chemical modifications that hamper a material's properties, such as electrical and thermal conductivity, and dependence on pH values or surfactants. Furthermore, such methods may not be readily applicable to other carbon-based materials.

Therefore, a need exists for versatile and easily implemented cross-linking protocols that would be applicable to various carbon-based materials without significantly affecting the structural integrity of the materials, and without significantly degrading transport properties of the materials (e.g., electrical and thermal conductivity). Various embodiments of the present disclosure address these needs.

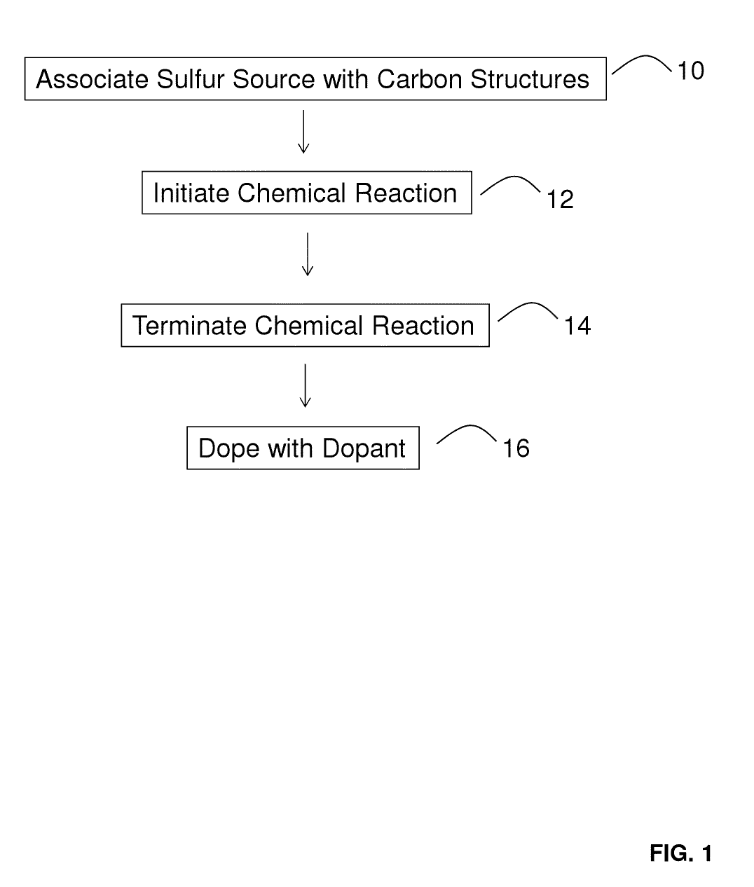

In some embodiments, the present disclosure pertains to methods of forming cross-linked carbon materials. In some embodiments illustrated in FIG. 1, the methods of the present disclosure include: associating a sulfur source with carbon materials, where the sulfur source comprises sulfur atoms (step 10); and initiating a chemical reaction (step 12), where the chemical reaction leads to the formation of covalent linkages between the carbon materials, and where the covalent linkages include covalent bonds between sulfur atoms of the sulfur source and carbon atoms of the carbon materials. In some embodiments, the methods of the present disclosure can also include a step of terminating the chemical reaction (step 14). In some embodiments, the methods of the present disclosure can also include a step of doping the carbon materials with a dopant (step 16).

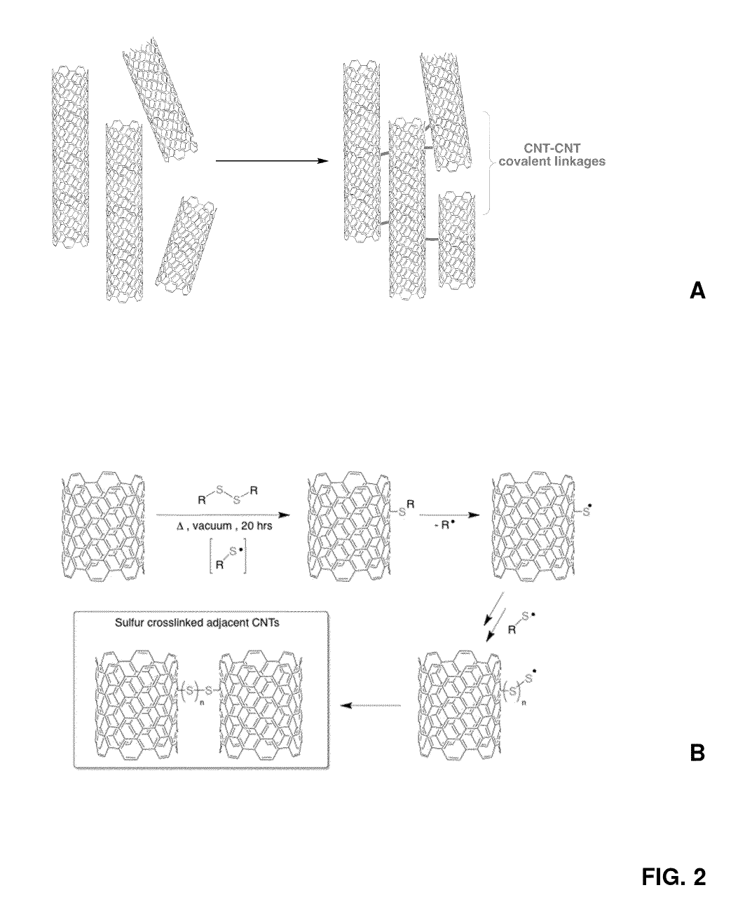

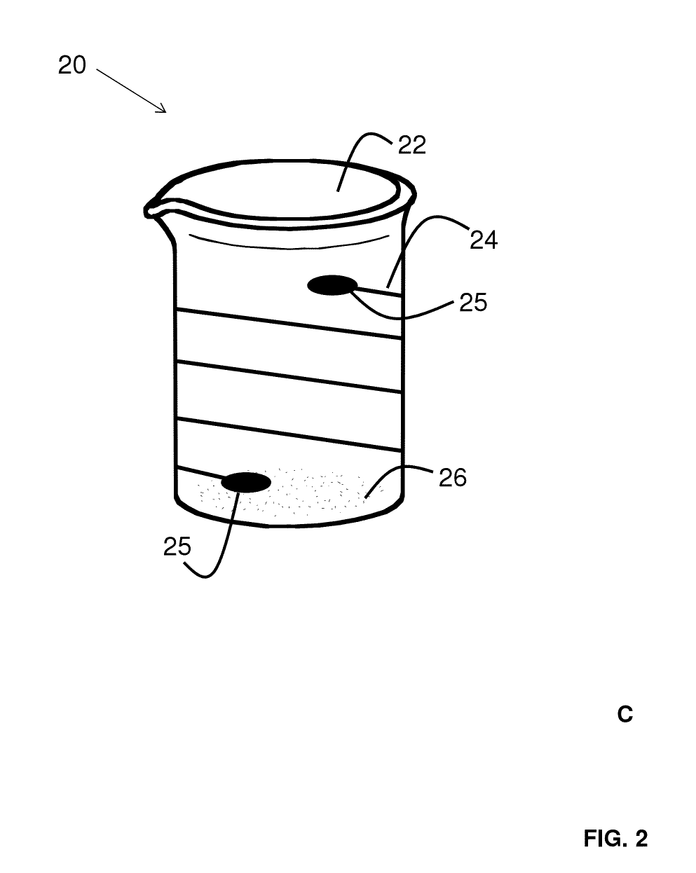

In more specific embodiments illustrated in FIGS. 2A-B, the present disclosure pertains to methods of forming cross-linked CNT fibers by associating a sulfur source with CNT fibers and initiating a radical reaction that leads to the formation of sulfur bridges between the CNT fibers. Further embodiments of the present disclosure pertain to cross-linked carbon materials formed in accordance with the methods of the present disclosure.

As set forth in more detail herein, various methods and chemical reaction conditions may be utilized to form various types of cross-linked carbon materials with various covalent linkages. Furthermore, various carbon materials, sulfur sources, and dopants may be utilized to form the cross-linked carbon materials of the present disclosure.

Carbon Materials

Various carbon materials may be utilized in the methods of the present disclosure. In some embodiments, suitable carbon materials can include, without limitation, non-polymeric carbon materials, carbon nanotubes, carbon nanotube fibers, carbon nanotube foams, carbon fibers, carbon foams, fullerenes, fluorenes, C₆₀, carbon films, graphenes, exfoliated graphite, graphene nanoribbons, graphite, and combinations thereof.

In some embodiments, suitable carbon materials include non-polymeric carbon materials. In some embodiments, suitable carbon materials include carbon nanotubes. In some embodiments, suitable carbon nanotubes can include, without limitation, single-wall carbon nanotubes, double-wall carbon nanotubes, multi-wall carbon nanotubes, carbon nanotube fibers, carbon nanotube foams, carbon nanotube tapes, carbon nanotube films, carbon nanotube coatings, other macroscopic carbon nanotube articles, and combinations thereof. In some embodiments, suitable carbon nanotubes can include pristine carbon nanotubes, un-functionalized carbon nanotubes, functionalized carbon nanotubes, and combinations thereof.

In some embodiments, suitable carbon materials for the methods of the present disclosure include carbon nanotube fibers. In more specific embodiments, suitable carbon materials include, without limitation, preformed carbon nanotube fibers, preformed single-wall carbon nanotube fibers, pre-formed double-wall carbon nanotube fibers, pre-formed and wet-spun carbon nanotube fibers, and combinations thereof.

In some embodiments, suitable carbon materials for the methods of the present disclosure include carbon nanotube foams. In more specific embodiments, the carbon materials of the present disclosure include, without limitation, preformed carbon nanotube foams, preformed single-wall carbon nanotube foams, preformed double-wall carbon nanotube foams, pre-formed and wet-processed carbon nanotube foams, and combinations thereof.

Carbon materials can be in various states during a chemical reaction. For instance, in some embodiments, carbon materials may be in a solid state during a chemical reaction. In some embodiments, carbon materials may be in a liquid state during a chemical reaction. In some embodiments, carbon materials may be in a gaseous state during a chemical reaction. In some embodiments, carbon materials may be in one or more of the above states (e.g., liquid and solid states) during a chemical reaction.

Sulfur Sources

The methods of the present disclosure may also utilize various types of sulfur sources. In some embodiments, the methods of the present disclosure may utilize sulfur sources that include, without limitation, elemental sulfur, oligomeric sulfur, 2,2′-dithiobis(benzothiazole) (DTBT), tetramethylthiuram disulfide (TMTD), phenyl-phenylthiosulfonate, benzenesulfonamide, phenyl thiobenzoate, 2-mercaptobenzothiazole, 2-mercaptobenzoxazole, diphenyl disulfide, 2-mercaptobenzimidazole, 1,3,4-thiadiazole-2,5-dithiol and combinations thereof. In some embodiments, suitable sulfur sources can include, without limitation, elemental sulfur, sulfur-based radical initiators, and combinations thereof.

In some embodiments, the methods of the present disclosure utilize sulfur sources that include elemental sulfur. In some embodiments, the elemental sulfur may be in oligomeric form.

In some embodiments, the methods of the present disclosure utilize sulfur sources that include sulfur-based radical initiators. In some embodiments, suitable sulfur-based radical initiators include, without limitation, 2,2′-dithiobis(benzothiazole) (DTBT), tetramethylthiuram disulfide (TMTD), 4-phenyl-phenylthiosulfonate, benzenesulfonamide, phenyl thiobenzoate, 2-mercaptobenzothiazole, 2-mercaptobenzoxazole, diphenyl disulfide, 2-mercaptobenzimidazole, 1,3,4-thiadiazole-2,5-dithiol and combinations thereof.

In some embodiments, the methods of the present disclosure utilize sulfur sources that include at least one source of elemental sulfur and at least one sulfur-based radical initiator. For instance, in some embodiments, the methods of the present disclosure may utilize a combination of elemental sulfur in oligomeric form, DTBT, and TMTD. In more specific embodiments, the methods of the present disclosure may associate a preformed CNT structure (e.g., CNT foam or CNT fiber) with elemental sulfur, DTBT, and TMTD.

Sulfur sources can also be in various states during a chemical reaction. For instance, in some embodiments, sulfur sources may be in a solid state during a chemical reaction. In some embodiments, sulfur sources may be in a liquid state during a chemical reaction. In some embodiments, sulfur sources may be in a gaseous state during a chemical reaction. In some embodiments, sulfur sources may be in one or more of the above states (e.g., solid and gaseous states) during a chemical reaction.

Chemical Reactions

The methods of the present disclosure may also occur under various chemical reaction conditions. For instance, in some embodiments, chemical reactions in accordance with the methods of the present disclosure occur in the absence of solvents. In more specific embodiments, chemical reactions may involve solvent-free sulfur vulcanization of carbon materials. In some embodiments, the carbon materials are in a solid-state during a solvent-free chemical reaction.

In some embodiments, the methods of the present disclosure occur in the presence of a solvent. In some embodiments, the solvent may include, without limitation, ether, isopropanol, 1,2-dichlorobenzene, water, acetone, dichloromethane, chloroform, toluene, and combinations thereof. In some embodiments, the carbon materials may be dissolved, suspended, or immersed in a solvent during a reaction. In some embodiments, chemical reactions in accordance with the methods of the present disclosure occur in the absence of surfactants. In some embodiments, chemical reactions in accordance with the methods of the present disclosure occur in the absence of irradiation (e.g., UV irradiation).

The methods of the present disclosure can also occur in various environments. For instance, in some embodiments, chemical reactions in accordance with the methods of the present disclosure occur in a reaction chamber. In some embodiments, the reaction chamber is a glass reaction chamber, such as a flask or a glass tube. In some embodiments, the reaction chamber is a stainless steel reaction chamber. In some embodiments, carbon materials are immobilized in a reaction chamber during the reaction. For instance, in some embodiments, carbon materials are immobilized by attachment to a weight, such as a glass particle (e.g., glass particles weighing about ˜100 mg). In more specific embodiments illustrated in FIG. 2C, the chemical reactions in accordance with the methods of the present disclosure occur in a reaction assembly 20 that includes flask 22, carbon materials 24 immobilized on a glass support rod inside of the flask through adhesive units 25, and sulfur source 26 positioned at the bottom of flask 22.

In some embodiments, chemical reactions in accordance with the methods of the present disclosure occur after associating a sulfur source with a carbon material. In some embodiments, the sulfur source is associated with a carbon material by placing both of the chemicals in proximity to or in contact with one another. In some embodiments, the association of a sulfur source with carbon materials occurs in a reaction chamber in the absence of solvents while the carbon materials are in a solid state and the sulfur source is in a solid, liquid, or gaseous state. In some embodiments, the association of a sulfur source with carbon materials occurs in a reaction chamber in the presence of a solvent while the sulfur source and the carbon materials are co-dissolved or co-immersed in the solvent.

Various methods may also be used to initiate chemical reactions. For instance, in some embodiments, a chemical reaction is initiated by heating a reaction chamber that includes a sulfur source and a carbon material. In some embodiments, the heating occurs between about 150° C. to about 200° C. In some embodiments, the heating occurs at temperatures of at least about 200° C. Without being bound by theory, homolytic cleavage of elemental sulfur generally occurs around 169° C. Therefore, Applicants envision that the heating of a chemical reaction to at least about 200° C. ensure substantially complete homolytic cleavage of the elemental sulfur.

The chemical reactions of the present disclosure may be heated for various periods of time. For instance, in some embodiments, heating occurs between about 1 hour and about 48 hours. In some embodiments, heating occurs between about 10 hours and about 20 hours. In some embodiments, heating occurs between about 14 hours and about 18 hours.

Additional methods and conditions may also be used to initiate the chemical reactions of the present disclosure. For instance, in some embodiments, the chemical reactions of the present disclosure may be initiated by placing the chemical reaction under vacuum (e.g., vacuums under pressures of 50-500 mTorr). In some embodiments, the chemical reactions of the present disclosure may be initiated by UV irradiation of the chemical reactions. In some embodiments, a chemical reaction is initiated by exposure of a sulfur source and a carbon material to electromagnetic fields, such as microwaves. In some embodiments, a chemical reaction is initiated by running a current through a sample containing a sulfur source and a carbon material. Additional methods of initiating chemical reactions can also be envisioned.

The chemical reactions of the present disclosure may occur for various periods of time. For instance, in some embodiments, the chemical reactions of the present disclosure may occur for about 3 hours to about 48 hours. In various embodiments, the chemical reactions of the present disclosure may occur for about 3 hours, 6 hours, 9 hours, 20 hours, 36 hours, or 48 hours.

In some embodiments, the methods of the present disclosure may also include a step of terminating chemical reactions. Various methods may also be utilized to terminate the chemical reactions of the present disclosure. For instance, in some embodiments, the chemical reactions of the present disclosure are terminated by cooling the chemical reaction. Without being bound by theory, Applicants envision that, upon the cooling of a chemical reaction, non-reacted sulfur and other remaining chemicals re-condense on the side of a reactor chamber vessel. This in turn can lead to the termination of the reaction. In some embodiments, the chemical reactions of the present disclosure are terminated by introduction of air or water to the chemical reaction. In more specific embodiments, a chemical reaction is terminated by introduction of air to the chemical reaction. In further embodiments, a chemical reaction is terminated by introduction of water to the chemical reaction.

Covalent Linkages

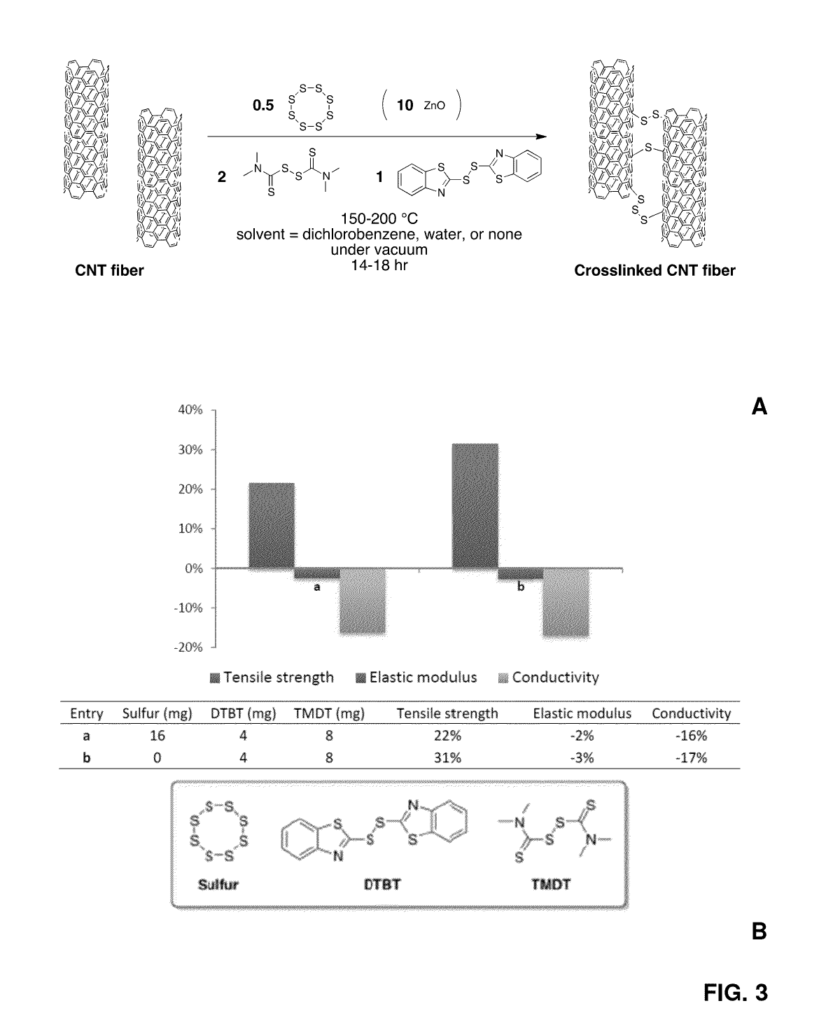

The methods of the present disclosure can lead to the formation of various types of covalent linkages between carbon materials. For instance, in some embodiments, covalent linkages comprise covalent bonds between sulfur atoms of a sulfur source and carbon atoms of carbon materials. In some embodiments, the covalent linkages include sulfur bridges between the carbon materials. See, e.g., FIG. 2B and FIG. 3A. In some embodiments, the sulfur bridges include at least one sulfur atom. In some embodiments, the sulfur bridges include a plurality of sulfur atoms. In some embodiments, the sulfur bridges include from about 1 sulfur atom to about 8 sulfur atoms. In some embodiments, the sulfur bridges include from about 1 sulfur atom to about 20 sulfur atoms. In some embodiments, the sulfur bridges include more than about 8 sulfur atoms.

Without being bound by theory, Applicants envision that covalent linkages between carbon materials can occur through radical reactions that form sulfur-based radicals. For instance, in some embodiments, sulfur-based radicals form the covalent linkages between carbon materials. In some embodiments, the sulfur-based radicals are added to walls of the carbon materials to form carbon-sulfur radical bonds that become linked to walls of additional carbon materials.

Doping

In some embodiments, the methods of the present disclosure may also include a step of doping the carbon materials with a dopant. In some embodiments, the doping occurs during a chemical reaction. In some embodiments, the doping occurs before a chemical reaction. In some embodiments, doping occurs after the completion of a chemical reaction.

The carbon materials of the present disclosure may be doped with various dopants. For instance, in some embodiments, the dopant may include at least one of iodine, chlorine, bromine antimony, phosphorous, boron, aluminum, gallium, selenium, tellurium, silicon, germanium, magnesium, zinc, cadmium, lithium, sodium, potassium, beryllium, magnesium, calcium, alkaline earth metals, alkali metals, and combinations thereof. In some embodiments, the dopant includes iodine.

Various methods may also be used to dope carbon materials with dopants. For instance, in some embodiments, the doping can occur by lithography, spraying, electro spraying, ion implantation, infiltration from a gaseous source and combinations of such methods.

Without being bound by theory, Applicants envision that the addition of dopants to carbon materials can help enhance their electrical conductivity. For instance, addition of sulfur to the sidewalls of carbon nanotubes can reduce the CNT's electrical conductivity by disrupting the conductive π-bonding network. In some embodiments, this loss of conductivity may be possible to mediate with doping.

Cross-Linked Carbon Materials

In further embodiments, the present disclosure pertains to cross-linked carbon materials that are formed by the methods of the present disclosure. In some embodiments, the present disclosure pertains to cross-linked carbon materials that include carbon materials and covalent linkages between the carbon materials.

In some embodiments, the carbon materials include non-polymeric carbon materials. In some embodiments, the carbon materials include, without limitation, carbon nanotubes, carbon nanotube fibers, carbon nanotube foams, carbon fibers, carbon foams, fullerenes, fluorenes, C₆₀, carbon films, graphenes, exfoliated graphite, graphene nanoribbons, graphite, and combinations thereof.

In some embodiments, the carbon materials include carbon nanotubes. In some embodiments, the carbon nanotubes include, without limitation, single-wall carbon nanotubes, double-wall carbon nanotubes, multi-wall carbon nanotubes, carbon nanotube fibers, carbon nanotube foams, carbon nanotube films, carbon nanotube coatings, carbon nanotube tapes, other macroscopic carbon nanotube articles, and combinations thereof. In some embodiments, the carbon materials include carbon nanotube fibers.

In some embodiments, the covalent linkages between the carbon materials include sulfur bridges between the carbon materials. In some embodiments, the sulfur bridges include covalent bonds between sulfur atoms and carbon atoms of carbon materials. In some embodiments, the sulfur bridges include a single sulfur atom. In some embodiments, the sulfur bridges include a plurality of sulfur atoms. In some embodiments, the sulfur bridges consist essentially of sulfur atoms.

In some embodiments, the cross-linked carbon materials of the present disclosure also include a dopant. In some embodiments, the dopant includes, without limitation, iodine, chlorine, bromine, antimony, phosphorous, boron, aluminum, gallium, selenium, tellurium, silicon, germanium, magnesium, zinc, cadmium, and combinations thereof. In some embodiments, the dopant is iodine.

In more specific embodiments, the present disclosure pertains to cross-linked carbon materials that include non-polymeric carbon materials and sulfur bridges between the carbon materials.

### Advantages

The methods of the present disclosure provide various advantages. For instance, because of elemental sulfur's relatively high vapor pressure, the methods of the present disclosure can be applied to various pre-formed carbon materials without the need of solvents or specialized conditions to facilitate chemical reactions. Moreover, sulfur and sulfur-containing precursors such as 2,2′-dithiobis(benzothiazole) (DTBT) and tetramethylthiuram disulfide (TMTD) are commonly available reactants and are inexpensive. Additionally, unlike many other functionalization techniques, sulfur is able to react directly with the sidewalls of various carbon materials (e.g., CNTs) without the need of chemical pretreatments. For instance, the methods of the present disclosure can take place under relatively mild conditions, such as temperatures below 250° C. and without irradiation. In some embodiments, the methods of the present disclosure can occur without the use of surfactants.

Therefore, the cross-linked carbon materials formed by the methods of the present disclosure provide numerous advantageous properties, including unique mechanical, electrical and thermal properties. For instance, in some embodiments, the cross-linked carbon materials of the present disclosure can show improvements in tensile strength of up to 60% in comparison to non-cross-linked carbon materials. In some embodiments, the cross-linked carbon materials of the present disclosure can show improvements in elastic modulus of up to 80% in comparison to non-cross-linked carbon materials. In some embodiments, the cross-linked carbon materials of the present disclosure can increase a carbon nanotube fiber's raw breaking force by up to about 40%, and a carbon nanotube fiber's tensile modulus by up to about 30%. In more specific embodiments, the methods of the present disclosure can increase a cross-linked CNT foam's Young's modulus by up to about 30%.

### Additional Embodiments

Reference will now be made to more specific embodiments of the present disclosure and experimental results that provide support for such embodiments. However, Applicants note that the disclosure below is for illustrative purposes only and is not intended to limit the scope of the claimed subject matter in any way.

### Example 1

### Solvent-Free Vulcanization of Carbon Nanotube Fibers for Physical Property Improvement

In this Example, Applicants present a facile method for improvement of the physical properties of carbon nanotube (CNT) fibers. Highly aligned CNT fibers produced via wet spinning were subjected to solvent-free sulfur vulcanization/crosslinking resulting in increased tensile strength and elastic modulus, although electrical conductivity was hampered. Addition of iodine dopant, either concurrent with crosslinking or in an additional step, led to significant improvement in electrical conductivities with no loss in mechanical properties. CNT crosslinking was characterized by Raman spectroscopy, X-ray photoelectron spectroscopy, and effective solubility. Because this crosslinking process is applied to pre-formed fibers, this method is expected to be applicable to CNT/graphene materials created by any process.

In this Example, Applicants relied on sulfur vulcanization to cross-link CNT fibers. Sulfur vulcanization involves crosslinking adjacent polymer chains with single or oligomeric sulfur bridges. Salient to its implementation with CNT-based materials, sulfur vulcanization occurs (at least partially) through a radical mechanism. Radicals are known to couple to the graphitic π system of CNTs, resulting in sidewall functionalization. In particular, sulfur-based radicals have recently been demonstrated to be reactive in this way and sulfur bridges have recently been used for toughening of graphite particles. Furthermore, polymer vulcanization is typically performed neat, without need for solvent.

In this Example, Applicants also applied sulfur vulcanization to wet-spun CNT fibers through the infiltration and subsequent reaction of sulfur-based radical precursors, ultimately resulting in a strengthened fiber through cross-linking. Without being bound by theory, the proposed mechanism is shown in FIG. 2B.

A typical formulation for crosslinking is elemental sulfur, zinc oxide, stearic acid, 2,2′-dithiobis(benzothiazole) (DTBT), and tetramethylthiuram disulfide (TMTD), which Applicants chose as a starting point for initial cross-linking conditions. A scheme for the above reaction is illustrated in FIG. 3A. Because of their negligible vapor pressures, zinc oxide and stearic acid were not included. Because oxygen may react unproductively with free radicals and to enhance the partition of reagents in the gas-phase, the reaction was performed under vacuum. Because the homolytic cleavage of elemental sulfur is known to occur around 169° C., the reaction was heated to 200° C. to ensure complete conversion.

As shown in FIG. 3B, an improvement in tensile strength was observed, leading to the conclusion that sulfur incorporation was successful. Elastic modulus remained constant for the cross-linked sample, but electrical conductivity decreased. Because vulcanization involves covalent modification of the CNT sidewalls, the conductive network is disrupted by conversion into sp³ carbon centers, partially breaking CNT conjugation. Interestingly, when tested in the absence of elemental sulfur, tensile strength increased even more, while conductivity and elastic modulus remained virtually constant, leading to the conclusion that the accelerants themselves were responsible for the cross-linking. This result is consistent with the fact that vulcanization may be performed even on polymers using an accelerant as the sole sulfur source.

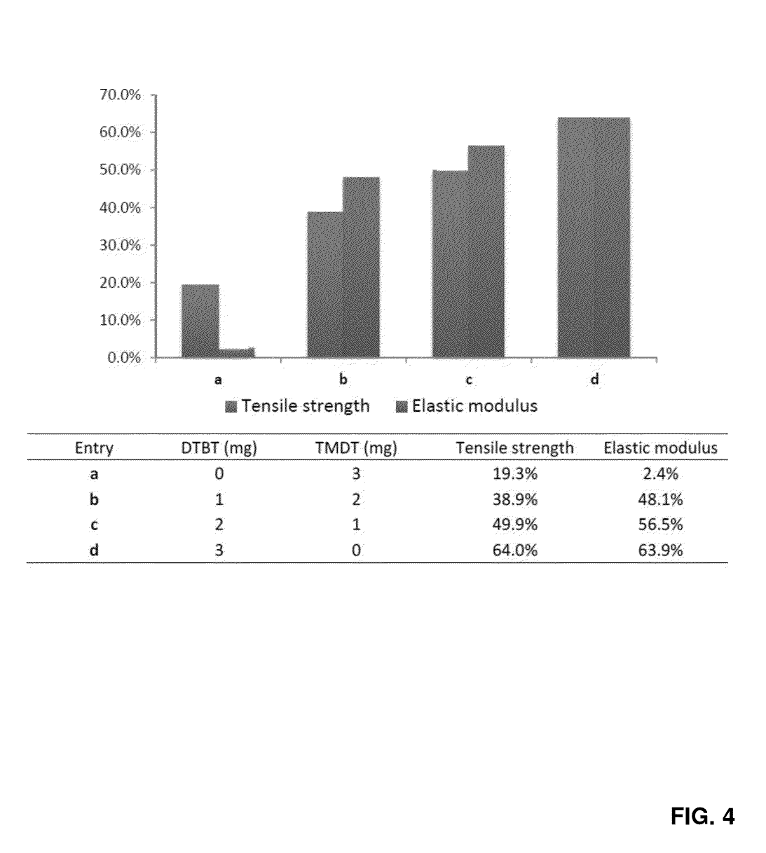

Next, Applicants investigated differing ratios of the two accelerants to determine an optimal reaction condition. As seen in FIG. 4, the improvements in tensile strength and particularly elastic modulus increase with increasing ratio of DTBT. Although TMTD alone does improve tensile strength slightly, it showed virtually no gains in elastic modulus, similar to the initial results. DTBT, however, showed a strong influence on both properties, particularly elastic modulus. With increasing ratio of DTBT, both tensile strength and elastic modulus increased.

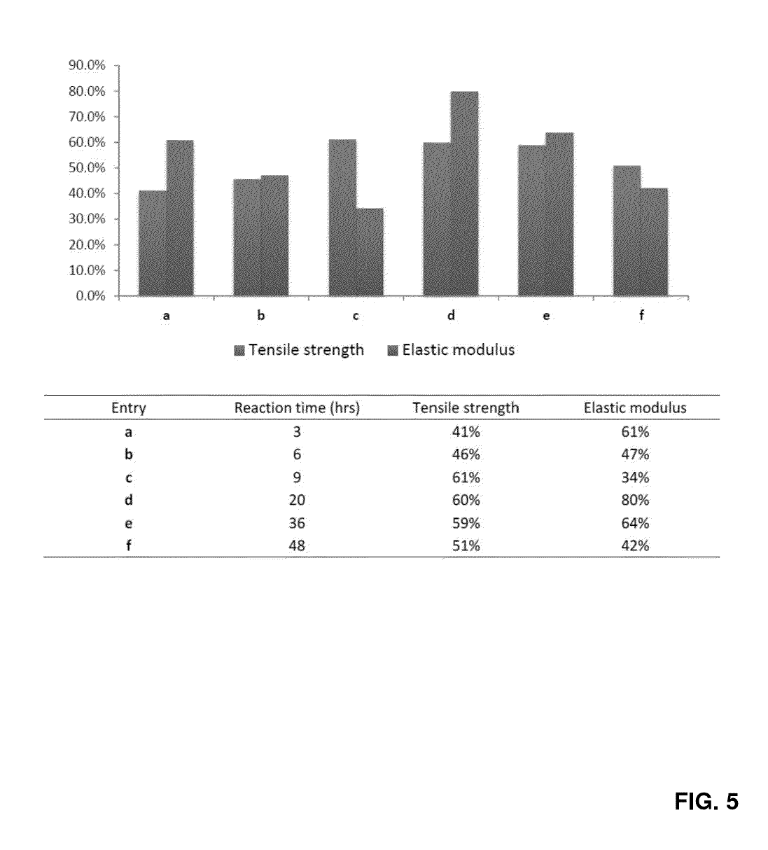

With DTBT determined to be the optimal vulcanization agent in this Example, the time of reaction was investigated. As shown in FIG. 5, the fiber tensile strength increases to its maximum (around 60% increase from unmodified fiber) in 9 hours, but the modulus does not reach its maximum until 20 hours. After 20 hours, a decline in both properties is observed, likely because of degradation of sulfur crosslinks under the reaction conditions. This is consistent with behavior observed in polymer vulcanization in the absence of stabilizers. These observations led to the conclusion that 20 hours is the optimal reaction time for both improved tensile strength and elastic modulus in this Example.

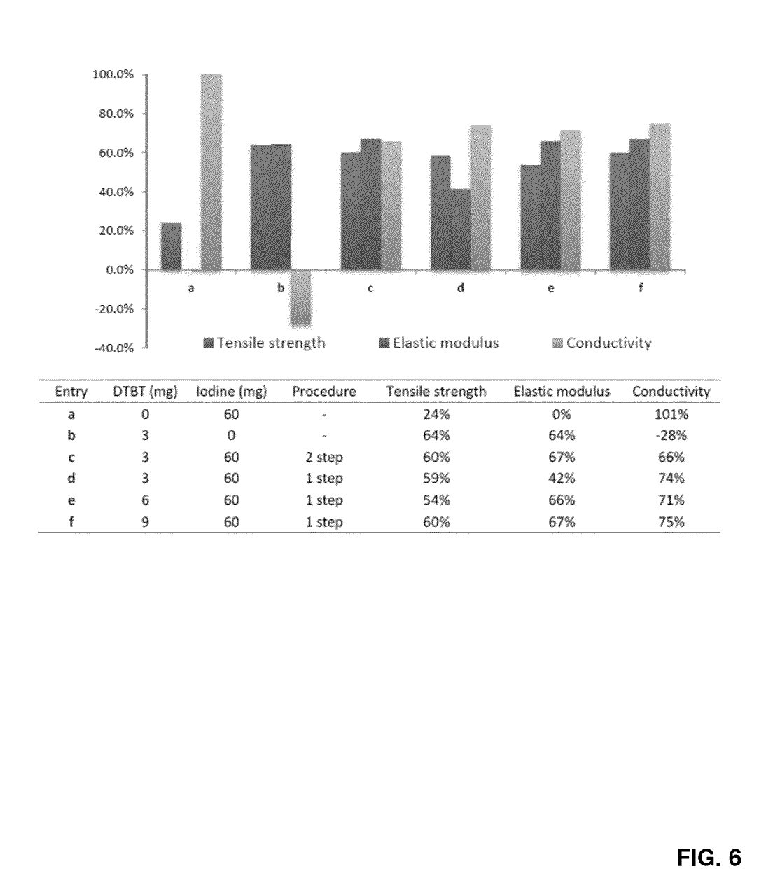

Despite the success of this sulfur vulcanization process at improving the tensile strength and elastic modulus of treated fibers, it was accompanied by a loss of electrical conductivity of 20-40%. Applicants had found that CNT fiber conductivity can be improved by doping with elemental iodine from the gas-phase. Applicants therefore attempted to dope already cross-linked fiber with elemental iodine in a separate second step as well as concurrent with sulfur vulcanization as shown in FIG. 6. As expected, electrical conductivity of the fiber was improved after iodine adoption. Moreover, tensile strength and modulus were unaffected by this second treatment. However, even though conductivity was 66% improved from the untreated fiber, it was still less than the 100% improvement possible with iodine doping but no crosslinking. The first attempt at combining crosslinking and iodine doping showed mixed results. Conductivity was improved as much as in the two-step process, and tensile strength was roughly the same, but the elastic modulus was significantly worse. Hypothesizing that iodine may have affected the vulcanization reagents, Applicants attempted the one step crosslinking/iodine doping with double and triple the initial amounts of DTBT. Additional DTBT increased the elastic modulus back to the same levels as during the two-step process, although there was very little improvement from the doubled to tripled conditions.

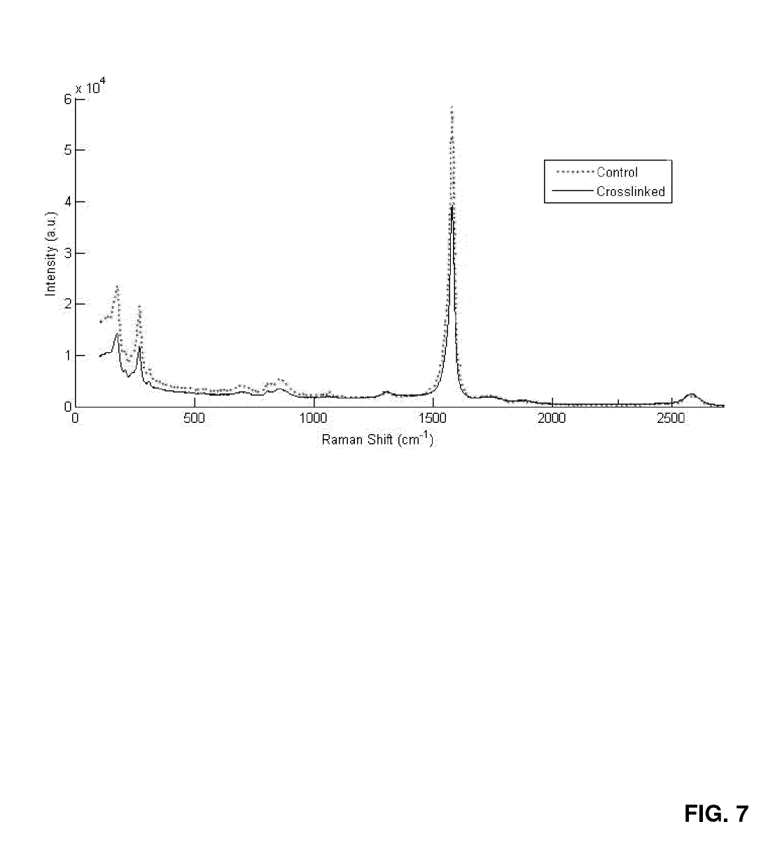

Finally, although successful sulfur vulcanization/crosslinking of CNT fibers is evident from the physical property improvements, Applicants sought to further characterize this process. First, Raman spectroscopy of the centralized fibers showed a decrease in the G band relative to the D band in comparison to untreated fiber (FIG. 7). This change is indicative of CNT sidewall functionalization and confirms that sulfur is covalently bound to the fiber nanotubes, rather than simply intercalated into void space.

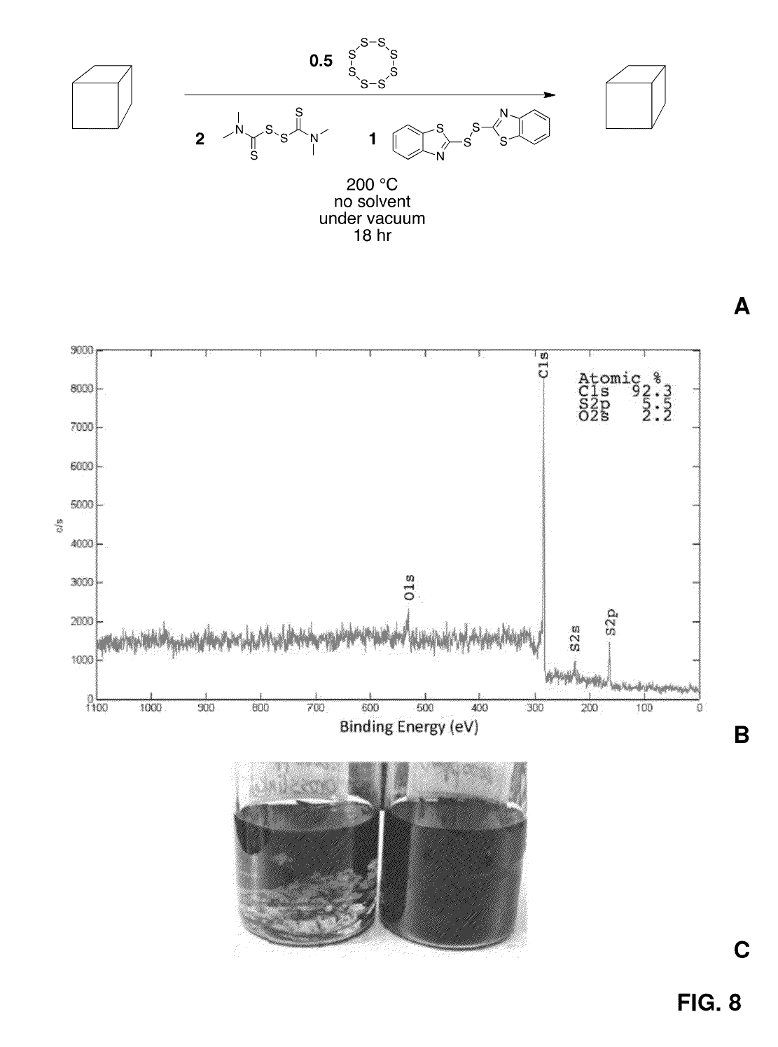

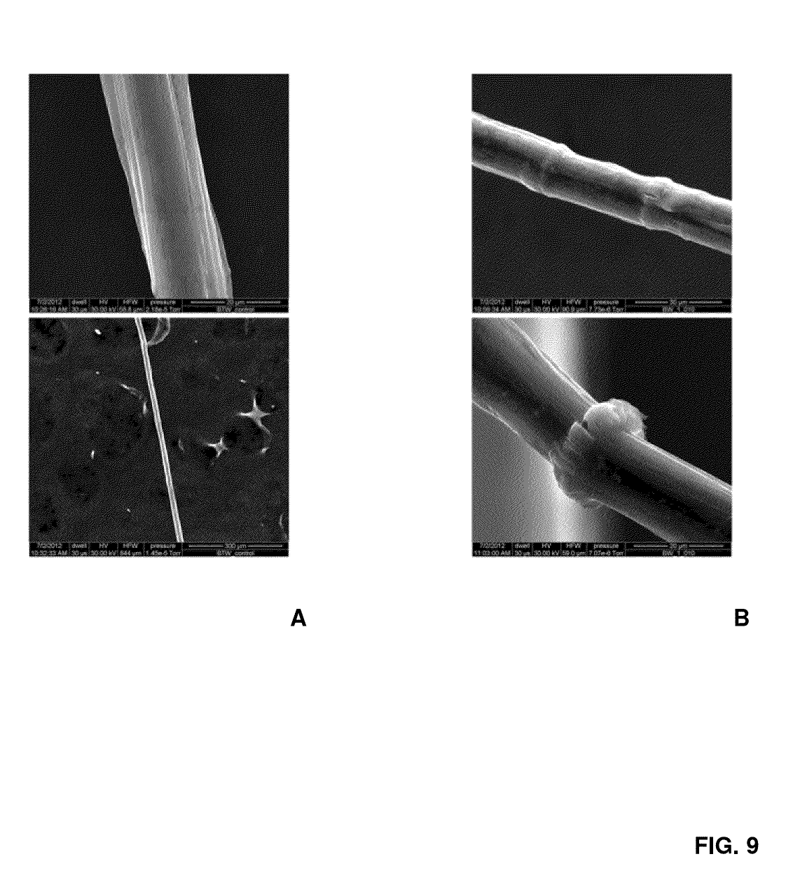

Next, Applicants investigated the above sulfur vulcanization process on CNT foam materials for the purposes of greater characterization. The scheme illustrated in FIG. 8A was implemented. After vulcanization, the foam structure showed 60% increased compressive elastic modulus, validating that vulcanization is valid for different geometries of CNT materials. The cross-linked foam was analyzed by X-ray photoelectron spectroscopy that indicated sulfur presence not present in untreated material (FIG. 8B). One final indication of crosslinking is reduced solubility, as chains are covalently bound and therefore unable to disperse.

Applicants attempted to re-dissolve the vulcanized foam into chlorosulfonic acid. However, the treated foam showed significantly less solubility than the untreated foam, which dissolved instantaneously (FIG. 8C).

In sum, Applicants report in this Example a sulfur vulcanization method for crosslinking CNT fibers to improve tensile strength and elastic modulus. The protocol is performed on pre-formed, wet-spun CNT fibers without solvent. In addition, the protocols show improvements in tensile strength of up to 60% and elastic modulus of up to 80% to that of untreated CNT fibers. Although electric conductivity decreases because of CNT sidewall modification, this effect can be mitigated through iodine doping, after which conductivity is close to that of iodine-doped fiber without crosslinking.

### Example 1.1

### Materials and Methods

CNT fibers were manufactured by a reported method (Science, 2013, 339, 182-186) using CNTs (purified grade) purchased from Continental Carbon Nanotechnologies Inc. (Houston, Tex.). Because of variability in fiber batches, all results are normalized to the unprocessed fiber properties from which they derived. All other chemicals were purchased from Sigma Aldrich and used without further purification. Raman spectra of CNT materials were measured using a Renishaw InVia Raman Confocal Raman microscope, with excitation wavelengths of 514, 633, and 785 nm. Scanning electron microscopy (SEM, FEI Quanta 400 ESEM FEG) was used to determine the diameter of the CNT fibers at a magnification of ˜10⁴ for a minimum of 4 segments of a 10-20 mm length of fiber. Mechanical testing of CNT fiber was performed on an Instron model 1000 testing frame with a 5 kg load cell as reported previously.

The CNT foam was produced by a method to be reported from the same CNT source as the CNT fibers. Surface analysis of the cross-linked foams by X-ray photoelectron spectroscopy (XPS) was performed using a Surface Science Instruments (SSI) M-probe XPS equipped with an Al Kα X-ray source operated at 10 kV and a base pressure of approximately 4.0×10⁻⁷ Pa. Spectra were recorded at a fixed take-off angle of 50°, and analyzed using the CASA XPS software, which has built-in corrections for spectrometer sensitivity factors for the SSI M-probe XPS. Compressive elastic modulus was measured at 60% strain (compression frequency of 0.5 Hz) using an Instron (Electropuls E3000) instrument and Wavematrix Software.

### Example 1.2

### Protocol for Sulfur Crosslinking

A length of CNT fiber was attached to a glass support rod by evaporation of a drop of 50% (w/w) sodium silicate solution in water, as a temperature stable and unreactive glue. The other end of the fiber was attached in the same fashion to a glass weight (˜100 mg) to provide tension on the fiber. The glass rod and fiber were added to a glass reaction tube loaded with DTBT (3 mg, 9 μmol). This reactor was fitted with a vacuum adapter sealed with copious vacuum grease. The reaction vessel was evacuated for five minutes and then sealed. The reactor was added upright (taking caution to ensure the fiber was hanging freely and under full tension from the glass weight) to an oven set at 200° C. The reactor was removed after 20 hours, after which the fiber was removed from the reactor, washed with a stream of acetone, and its resistance was measured by four-point probe. Mechanical analysis was performed as described (Science, 2013, 339, 182-186) to determine tensile properties.

### Example 1.3

### Protocol for Iodine-Cured Vulcanized Fibers

Using the same supported fiber under tension as described in sulfur crosslinking before tensile testing, iodine (60 mg, 470 μmol) was added to the glass reactor. The reactor was evacuated for 5 minutes, then added to an oven set at 200° C. for 20 hours. Afterwards, the fiber was worked up as described in the sulfur crosslinking protocol.

### Example 1.4

### Protocol for 1-Step Vulcanization/Iodine Curing

This method follows the protocol for sulfur crosslinking except both DTBT (3 mg, 9 μmol or 6 mg, 18 μmol) and iodine (60 mg, 470 μmol) were added concurrently and a single 20 hour heating cycle was conducted.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A method of forming cross-linked carbon materials, wherein the method comprises:
(a) associating a sulfur source with carbon materials, wherein the sulfur source comprises sulfur atoms; and
(b) initiating a chemical reaction,
wherein the chemical reaction leads to the formation of covalent linkages between the carbon materials, and
wherein the covalent linkages comprise covalent bonds between sulfur atoms of the sulfur source and carbon atoms of the carbon materials.

2. The method of claim 1, wherein the carbon materials comprise non-polymeric carbon materials.

3. The method of claim 1, wherein the carbon materials are selected from the group consisting of non-polymeric carbon materials, carbon nanotubes, carbon nanotube fibers, carbon nanotube foams, carbon fibers, carbon foams, fullerenes, fluorenes, C₆₀, carbon films, graphenes, exfoliated graphite, graphene nanoribbons, and combinations thereof.

4. The method of claim 1, wherein the carbon materials comprise carbon nanotubes.

5. The method of claim 4, wherein the carbon nanotubes are selected from the group consisting of single-wall carbon nanotubes, double-wall carbon nanotubes, multi-wall carbon nanotubes, carbon nanotube fibers, carbon nanotube foams, carbon nanotube tapes, carbon nanotube films, carbon nanotube coatings, other macroscopic carbon nanotube articles, and combinations thereof.

6. The method of claim 1, wherein the carbon materials comprise carbon nanotube fibers.

7. The method of claim 1, wherein the carbon materials are in a solid state during the chemical reaction.

8. The method of claim 1, wherein the sulfur source is selected from the group consisting of elemental sulfur, oligomeric sulfur, 2,2′-dithiobis(benzothiazole) (DTBT), tetramethylthiuram disulfide (TMTD), phenyl-phenylthiosulfonate, benzenesulfonamide, phenyl thiobenzoate, 2-mercaptobenzothiazole, 2-mercaptobenzoxazole, diphenyl disulfide, 2-mercaptobenzimidazole, 1,3,4-thiadiazole-2,5-dithiol, and combinations thereof.

9. The method of claim 1, wherein the sulfur source comprises elemental sulfur.

10. The method of claim 1, wherein the sulfur source comprises a sulfur-based radical initiator.

11. The method of claim 10, wherein the sulfur-based radical initiator is selected from the group consisting of 2,2′-dithiobis(benzothiazole) (DTBT), tetramethylthiuram disulfide (TMTD), 4-phenyl-phenylthiosulfonate, benzenesulfonamide, phenyl thiobenzoate, 2-mercaptobenzothiazole, 2-mercaptobenzoxazole, diphenyl disulfide, 2-mercaptobenzimidazole, 1,3,4-thiadiazole-2,5-dithiol, and combinations thereof.

12. The method of claim 1, wherein the chemical reaction occurs in the absence of solvents.

13. The method of claim 1, wherein the chemical reaction occurs in the absence of surfactants.

14. The method of claim 1, wherein the carbon materials are immobilized in a reaction chamber during the chemical reaction.

15. The method of claim 1, wherein the initiating of the chemical reaction comprises heating

16. The method of claim 15, wherein the heating occurs between about 150° C. to about 200° C.

17. The method of claim 15, wherein the heating occurs at temperatures of at least about 200° C.

18. The method of claim 1, wherein the initiating of the chemical reaction comprises UV irradiation.

19. The method of claim 1, wherein the initiating of the chemical reaction comprises placing the chemical reaction under vacuum.

20. The method of claim 1, further comprising a step of terminating the chemical reaction.

21. The method of claim 20, wherein the terminating of the chemical reaction comprises cooling the chemical reaction.

22. The method of claim 1, wherein the covalent linkages comprise sulfur bridges between the carbon materials

23. The method of claim 22, wherein each of the sulfur bridges comprises a plurality of sulfur atoms.

24. The method of claim 1, wherein the chemical reaction comprises radical reactions that form sulfur-based radicals, wherein the sulfur-based radicals form the covalent linkages between the carbon materials.

25. The method of claim 1, further comprising a step of doping the carbon materials with a dopant.

26. The method of claim 25, wherein the doping occurs during the chemical reaction.

27. The method of claim 25, wherein the doping occurs after the chemical reaction.

28. The method of claim 25, wherein the dopant is selected from the group consisting of iodine, chlorine, bromine, antimony, phosphorous, boron, aluminum, gallium, selenium, tellurium, silicon, germanium, magnesium, zinc, cadmium, lithium, sodium, potassium, beryllium, magnesium, calcium, alkaline earth metals, alkali metals, and combinations thereof.

29. The method of claim 25, wherein the dopant comprises iodine.

30. Cross-linked carbon materials comprising:
carbon materials, wherein the carbon materials are non-polymeric; and
covalent linkages between the carbon materials, wherein the covalent linkages comprise sulfur bridges between the carbon materials.

31. The cross-linked carbon materials of claim 30, wherein the carbon materials are selected from the group consisting of carbon nanotubes, carbon nanotube fibers, carbon nanotube foams, carbon fibers, carbon foams, fullerenes, fluorenes, C₆₀, carbon films, graphenes, exfoliated graphite, graphene nanoribbons, graphite, and combinations thereof.

32. The cross-linked carbon materials of claim 30, wherein the carbon materials comprise carbon nanotubes.

33. The cross-linked carbon materials of claim 32, wherein the carbon nanotubes are selected from the group consisting of single-wall carbon nanotubes, double-wall carbon nanotubes, multi-wall carbon nanotubes, carbon nanotube fibers, carbon nanotube tapes, carbon nanotube films, carbon nanotube coatings, carbon nanotube foams, other macroscopic carbon nanotube articles, and combinations thereof.

34. The cross-linked carbon materials of claim 30, wherein the carbon materials comprise carbon nanotube fibers.

35. The cross-linked carbon materials of claim 30, wherein the sulfur bridges comprise a plurality of sulfur atoms.

36. The cross-linked carbon materials of claim 30, wherein the sulfur bridges consist essentially of sulfur atoms.

37. The cross-linked carbon materials of claim 30, wherein the carbon materials further comprise a dopant.

38. The cross-linked carbon materials of claim 37, wherein the dopant is selected from the group consisting of iodine, chlorine, bromine, antimony, phosphorous, boron, aluminum, gallium, selenium, tellurium, silicon, germanium, magnesium, zinc, cadmium, lithium, sodium, potassium, beryllium, magnesium, calcium, alkaline earth metals, alkali metals, and combinations thereof.

39. The cross-linked carbon materials of claim 37, wherein the dopant comprises iodine.
